(19) United States
(12) Patent Application Publication
(10) Pub. No.: US 2006/0116805 A1
(43) Pub. Date: Jun. 1, 2006

(54) Method for monitoring an adhesion actuated transmission

(75) Inventor: Karlheinz Braun, Wernau (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/189,807

(22) Filed: Jul. 27, 2005

(30) Foreign Application Priority Data
Jul. 28, 2004 (DE) 102004036503.2-14

(51) Int. Cl. G06F 17/00

(52) U.S. Cl. 701/51; 477/906; 701/63

(57) ABSTRACT

Method for monitoring an adhesion-actuated transmission, a monitoring variable being detected. In a first comparison step, at least the one monitoring variable is correlated with reference data and a counter value is incremented or decremented as a function of the correlation result, and, in a second comparison step, the counter value is compared with a counter threshold value, and a fault signal is generated in the event of the overshooting of the counter threshold value.

This application claims the priority of German Patent Document No. 10 2004 036 503.2-14, filed Jul. 28, 2004, the disclosure of which is expressly incorporated by reference herein.

### BACKGROUND AND SUMMARY OF THE INVENTION

The invention relates to a method for monitoring an adhesion-actuated transmission, such as, for example, a continuously variable automatic transmission (CVT transmission).

Such a continuously variable automatic transmission is also designated below as a CVT transmission. A continuously variable automatic transmission conventionally consists, inter alia, of a starting unit, of a forward/reverse drive unit, of an intermediate shaft, of a differential, of hydraulic and electrical or electronic control devices and of a variator. A conventional variator has a primary pulley set, a secondary pulley set and a wrap-around element. The transmission control sets the necessary pressure forces (primary pressure, secondary pressure) on the primary pulley set and/or on the secondary pulley set, in order to make the necessary adhesive connection or frictional connection of the transmission. The engine torque is in this case transmitted between the transmission components by means of (static) friction. However, the invention can basically also be applied to other types of adhesion-actuated transmissions.

The construction and functioning of a known CVT automatic transmission are described, for example, in German patent publication DE 196 50 218 A1. This describes a method for controlling a CVT automatic transmission, rotational speeds of the primary pulleys and of the secondary pulleys being determined. From these rotational speeds, an operating point is determined and is compared with value ranges in a characteristic map for admissible and inadmissible values. If the operating point overshoots the limit of an inadmissible range, a fault is detected and, in a first step, the pressure level of the secondary pulley is increased. If the operating point continues to lie outside the admissible range, that is to say a fault is still detected, then, in a second step, an emergency drive program is activated. In this method, therefore, when a deviation from the admissible range occurs, immediately a fault is detected and a corresponding regulating measure is initiated.

German patent publication DE 199 52 476 A1 describes a method for controlling a CVT automatic transmission, in which a main pressure and a pressure force of a secondary pulley are detected and arrive as signals at an electronic transmission control. To diagnose a fault in the sensing of the main pressure and/or of the pressure force of the secondary pulley, its actual values or comparative quantities formed from these are compared with threshold values, in order to check the detected values for plausibility. If at least one of the threshold values is overshot, a corresponding fault signal is generated. Even in this method, therefore, a fault is detected immediately when a deviation from the admissible range occurs or when a threshold value is overshot.

German patent specification DE 199 37 472 C1 describes a method for the treatment of variator slip in continuously variable automatic transmissions. There, when variator slip is detected, inter alia, a weighted slip counter is counted up via an evaluation module, the variator slip being weighted in terms of duration and intensity by means of the evaluation module. This weighted counter has appended to it a slip status counter characteristic map which is incremented by means of the weighted slip counter. In parallel with the incrementation of the counters, a belt slip fault is entered in a fault store. Thus, once again, a fault is detected immediately when slip occurs and a fault entry having the corresponding status data is generated. In parallel with this, monitoring is carried out as to whether the overall pressure force safety overshoots a defined level. If this is so, that is to say if a defined threshold value for the monitored overall pressure force safety is overshot, then a fault warning is immediately generated again and the reaction is a substitute function (for example, hydraulic emergency running).

German patent publication DE 102 25 285 A1 describes a method for regulating the torque transmission capacity of an automatic transmission. In this case, the input rotational speed and output rotational speed and/or the drive torque and driven torque are detected, a correlation value is calculated from these two variables and it is determined whether the difference between the calculated correlation value and a predetermined correlation value overshoots a defined threshold value. If this is so, a fault (slip) is immediately detected and a manipulated variable is changed in order to reduce said difference.

What is inherent to all the abovementioned known technical teachings is that at least one monitoring variable is detected and is correlated or compared with reference data either immediately or after a conversion step. In the event of a fault, a fault signal is generated immediately as a function of this correlation result or comparison result.

All these methods have the disadvantage, however, that a longterm observation of the development in time of monitoring variables precisely with a view to a selfhealing of the system is not possible, since a fault is detected immediately in the case of a corresponding correlation result or comparison result and a corresponding regulating measure up to and including emergency running is initiated.

Against this background, then, the object on which the present invention is based is to provide an improved method for monitoring an adhesion-actuated transmission.

This object is achieved, according to the invention, a method as described and claimed hereinafter and by a data store as described and claimed hereinafter.

Accordingly, what is provided is:

a method for monitoring an adhesion-actuated transmission, in particular a CVT transmission, at least one monitoring variable being detected and a fault signal being generated as a function of comparison results, in a first comparison step at least the at least one monitoring variable being correlated with reference data and a counter value being incremented or decremented as a function of the correlation result, and, in a second comparison step, the counter value being compared with a counter threshold value and a fault signal being generated in the event of an overshooting of the counter threshold value.

A data store with stored data or data-representing signal trains, the data constituting a monitoring algorithm for an adhesion-actuated transmission for running in an electronic transmission control. The monitoring algorithm contains: a first comparison routine, in which a monitoring variable is read in by a sensor, is correlated with reference data which are stored in a reference data store (MP2des), and a counter value is incremented or decremented as a function of the correlation result, and a second comparison routine, in which the counter value is compared with a counter threshold value stored in a counter threshold value store, and a fault signal is generated in the event of the overshooting of the counter threshold value.

The idea on which the present invention is based is that, in contrast to the known solutions mentioned initially, according to the invention there is a two-step monitoring or decision method. A fault signal is not generated immediately in the event of deviation, such as, for example, the overshooting of reference values or threshold values, but, instead, advantageously, firstly correlation information is transferred from a first monitoring or decision step into a second monitoring or decision step. Only if a threshold value in this monitoring or decision step is overshot is the fault signal generated. It thereby becomes possible to have precisely an intermediate selfhealing of the system which makes it unnecessary to trigger a fault signal.

The invention thus allows a long term observation of the development of the system in time, without an emergency running reaction, possibly unnecessary in objective terms, being triggered immediately in the event of the overshooting of defined threshold values. The monitoring of the monitoring variables and the corresponding monitoring or decision step are consequently advantageously decoupled in time from the generation of a fault signal and the corresponding monitoring or decision step.

Advantageous refinements and developments of the invention are the subject matter of the subclaims and of the description, with reference to the drawing.

According to a first development of the invention, in the first comparison step, the overshooting or undershooting of a threshold value (monitoring variable threshold value) is interrogated for a function of the monitoring variable and, in the event of the overshooting or undershooting of a threshold value, the counter value is incremented or decremented. Such a threshold value comparison constitutes a measure which is particularly simple to implement. In principle, the determined monitoring variable or its value could also be compared directly with a threshold value and the corresponding comparison result be used, as described above, for the further method.

What will preferably be provided, however, is that first, in the first comparison step, the at least one monitoring variable is correlated with a monitoring variable reference value, in that a deviation of the at least one monitoring variable from the reference value is determined, and a function of the deviation is compared with the threshold value of the first comparison step, instead of a function of the monitoring variable itself being compared directly with the threshold value. In the event of the overshooting or undershooting of the threshold value, the counter value is then incremented or decremented, as stated above.

In particular, what may also be provided is that, in a further processing step, a further-processed deviation signal is determined as a function of the determined deviation by means of a weighting and/or filtration and/or limitation of the determined deviation. Owing to such further processing, the deviation signal can be optimized and, if appropriate, even adapted dynamically to changed conditions. This further-processed deviation signal can then be compared with the abovementioned monitoring variable threshold value by the method according to the invention.

What is preferably provided is that the monitoring of the adhesion-actuated transmission takes place with the aid of a data processing monitoring algorithm, a diagnostic signal being used as a first input signal for starting the monitoring algorithm, and the monitoring variable and/or the determined deviation and/or the further-processed deviation signal being used as a second input signal of the monitoring algorithm. The diagnostic signal serves for providing a defined starting point for the monitoring algorithm, in order to ensure that, at the start of the algorithm, for example, defined minimum stipulations or operating states are fulfilled.

The diagnostic signal can be generated, in particular, from diagnostic data of an electronic transmission control and from diagnostic data of further devices functionally connected to the transmission, such as diagnostic data of an engine, sensors or hydraulic devices.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a flowchart for illustrating the method according to the invention.

FIG. 2 shows a detailed illustration of an exemplary monitoring algorithm corresponding to the flowchart in FIG. 1.

### DETAILED DESCRIPTION OF THE DRAWINGS

Unless specified otherwise, identical or functionally identical elements have been given the same reference symbols in all the figures of the drawing.

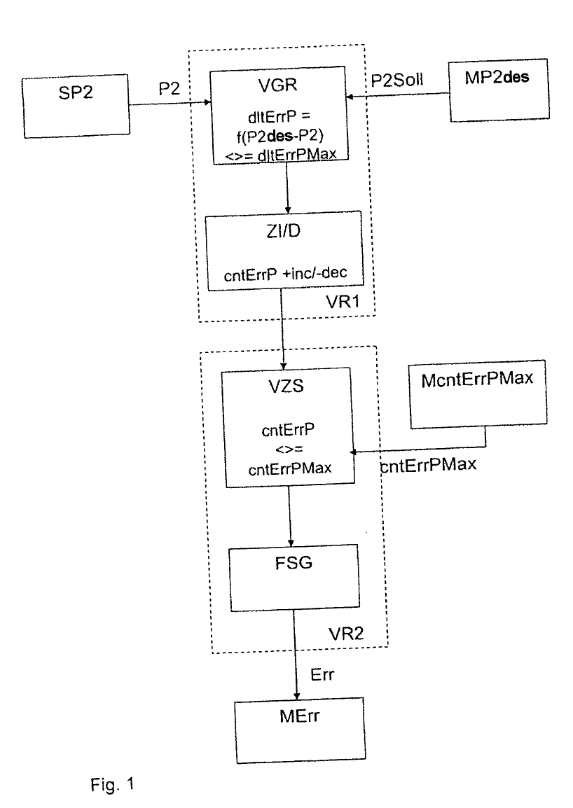

FIG. 1 shows a flowchart for illustrating the method according to the invention, the method being implemented with the aid of a data processing algorithm. This method is explained below, by way of example, by means of pressure measurement on a continuously variable automatic transmission which is inserted in the drive train of a motor vehicle. The algorithm may be present, stored permanently, in a data store of the transmission control, such as a semiconductor chip, a memory card or the like. Additionally or alternatively, the algorithm may also be transmitted in a suitable way in the form of a signal train to the required location in the system.

In the method according to the invention, a sensor SP2 generates a monitoring variable P2 which, in this example, constitutes the secondary pressure on the secondary pulley set SS2 of a CVT automatic transmission, such as is known, for example, from the initially mentioned DE 196 50 218 A1.

For this example, some interrelations for monitoring a pressure signal in a continuously variable transmission will be explained briefly below:

a) current ignition run means: the engine is running and pressure is regulated/controlled, the electrical/electronic transmission control unit is activated and all the valves are regulated/controlled.

b) for adjusting a variator having a primary pulley set SS1 and a secondary pulley set SS2, the following force ratio FPFS:=(−Fₚ/Fₛ) between the primary force Fₚ on the primary pulley set SS1 and the secondary force Fₛ on the secondary pulley set SS2 is necessary:
FPFS>>1: Adjustment of the variator into the position “OD” (Overdrive);
FPFS=1: no adjustment of the variator;
FPFS<<1: Adjustment and/or clamping of the variator in the position “LOW” (=starting stepup)

c) the primary force Fₚ, taking into account all the spring forces and centrifugal forces on the pulley set SS1, is generated by the primary pressure P1 being exerted on the corresponding piston surface of the hydraulic device at the primary pulley set SS1.

d) the same applies similarly to the secondary force Fₛ which is generated with the aid of the secondary pressure P2 on the side of the secondary pulley set SS2.

e) in the event of an adjustment of the variator toward “LOW”, the primary pulley set SS1 must be emptied and the secondary pulley set SS2 filled.

In the present example, at least the secondary pressure P2 on the secondary pulley set SS2 is to be monitored as the monitoring variable, since this is the most important pressure in the CVT transmission and, moreover, corresponds to the system pressure/working pressure. The method described by means of the present example may also be applied to the monitoring of CVT transmissions in which more than one pressure is to be monitored.

An electrical or electronic monitoring of a pressure sensor signal which corresponds to the monitoring variable P2 takes place permanently by means of near-hardware data processing routines in the transmission control or, typically, at a low program level. The method is preferably designed in such a way that a failure of the pressure sensor due to an electrical fault, such as, for example, a short circuit or line break, leads directly to emergency running. In this case, the monitoring method described below is switched off immediately, since the further monitoring then makes no sense because of an absence of input variables. The monitoring method is therefore carried out, as described here, only for as long as the pressure sensor supplies values for the monitoring variable P2 as input variables for the method.

Effects of a pressure P2 outside a valid/admissible range: during the normal regulation or normal control of a CVT transmission, the pressure force P2 is permanently monitored and adjusted. Should the pressure P2 be lower than its stipulated value P2des, then the necessary pressure force for supporting the prevailing engine torque is not available and the wrap-around element may slide through (slip) or other components of the drive train may be damaged permanently. If the pressure force P2 is too high, this may result in increased fuel consumption on account of a higher load on the engine. In addition, damage in the transmission on account of overload, such as, for example, bearing damage, may also occur.

The method described with reference to the present example is therefore aimed at the detection of a false pressure signal, that is to say of a pressure P2 which, because of hydraulic and/or mechanical defects, lies outside an admissible value or range while the drive train is running (engine running, no electrical fault), so that, for example, no expedient pressure regulation is possible. This would normally lead to the failure of the transmission.

The method according to the invention, corresponding to the example in FIG. 1, basically functions as follows:

The filtered control deviation between desired pressure P2des and actual pressure P2 is compared with a data-based maximum threshold and, if appropriate, is further processed once again, for example by careful filtering. The term “data-based” means, in this respect, that the maximum threshold can be varied or can be set as a function of the respective application and therefore as a function of the predetermined data. In the event of an overshooting or undershooting of said threshold, a counter is incremented or decremented. Only when this counter overshoots a further threshold is a fault detected and stored in the fault store of the electronic transmission control, and further measures, such as, for example, the triggering of emergency running, are initiated as a function of the stored fault entry.

For this purpose, according to FIG. 1, the monitoring variable P2 is fed to a first comparison routine VR1. In a first subroutine VGR of the comparison routine VR1, the value of the monitoring variable P2 is correlated with a reference value P2des which is stored in a reference data store MP2des. Correlation, here, takes place first by the calculation of the deviation (P2des−P2) of the monitoring variable P2 from the reference value P2des. The determined value for this deviation is further processed and a value dltErrP as a function F (P2des−P2) is determined as the result. This value dltErrP is compared with a defined threshold value dltErrPMax (monitoring variable threshold value).

If dltErrP overshoots the defined threshold value dltErrPMax, that is to say if dltErrPMax=f(P2des−P2)>=dltErrPmax, then, in a second subroutine ZI/D of the first comparison routine VR1, a counter cntErrP is increased by one increment inc. If dltErrP undershoots the defined threshold value dltErrPMax, then, in the second subroutine ZI/D of the first comparison routine VR1, the counter cntErrP is lowered by one decrement dec.

The current counter value cntErrP is fed to a second comparison routine VR2. In this second comparison routine VR2, first, in a first subroutine VZS, the current counter value cntErrP is compared with a counter threshold value cntErrPMax which is stored in a counter threshold value store McntErrPMax and which is read out from this counter threshold value store McntErrPMax by the subroutine VZS. If the current counter value cntErrP overshoots the threshold value cntErrPMax, then, in a second subroutine FSG of the second comparison routine VR2, a fault signal Err is generated. This fault signal Err is transferred at least to a fault store MErr. The stored fault signal Err can then be accessed by the transmission control, and suitable measures can be initiated as a function of the fault signal Err. However, the fault signal MErr may also be transferred directly to suitable control and regulating devices, in order to counteract the detected fault or to initiate emergency running.

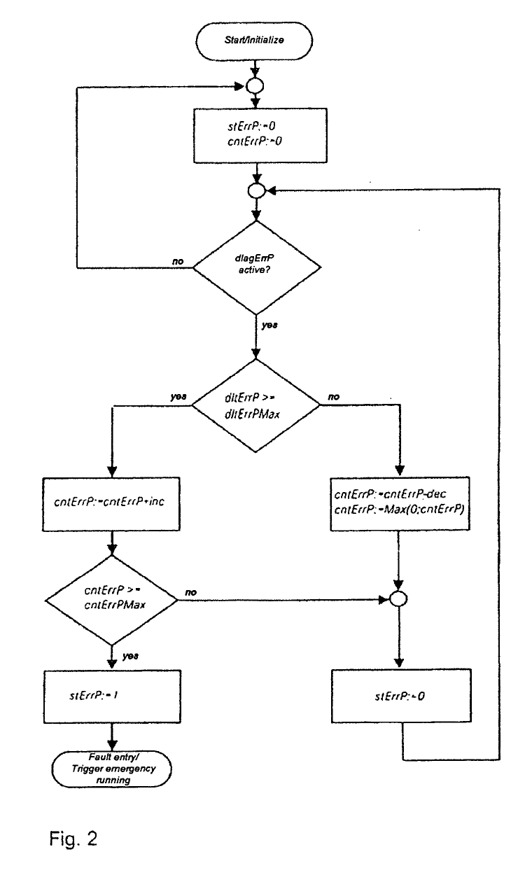

With reference to FIG. 2, then, further details of the data processing algorithm, as an example of the method according to the invention, are explained. As already stated, the algorithm has two input variables or input signals diagErrP and the pressure signal P2, from which a variable stErrP, explained in more detail below, is formed. The input signal diagErrP is generated as follows:
diagErrP:={[Initialization is concluded] && [Engine is running stably (no starter operation)] && [no electrical pressure sensor fault] && [hydraulic pump is running]}

The condition “hydraulic pump is running” may, for example, be derived from the fact that the hydraulic pump connected directly to the engine can build up a pressure only when the engine is running. In this case, a minimum rotational speed threshold of the engine may be expedient as a threshold value to be detected.

In this example, the signal diagErrP serves for activating the algorithm according to FIG. 1 or FIG. 2. In principle, however, the algorithm may also be started in another way. The value range is binary: zero or one. “Zero” means that no appropriate monitoring is possible and the algorithm is switched off or is reset. “One” means that monitoring is activated.

A further basic signal dltErrP for the algorithm is derived from the second input signal P2 or from the regulating error P2des−P2 for this input signal as follows:
dltErrP:=ABS(prefct(P2des−P2))

In normal regulating or control operation, pressure peaks or desired pressure jumps are always possible, so that monitoring would cut in too quickly if each of these pressure peaks or desired pressure jumps were characterized as faults, and would therefore lead to unnecessary system failure due to emergency running. Here, therefore, the deviation (P2des−P2) is first further processed in the function “prefct”. This function “prefct” may contain a low pass filter and/or gradient limitation and/or asymmetric weighting as a function of the control deviation (P2des−P2), etc. The amount (ABS function) is subsequently formed. The formation of an amount is not absolutely necessary, but simplifies the algorithm. As a result of this function “prefct” and amount formation, any deviation is not evaluated immediately, but, instead, only permanently acquirable hydraulic and/or mechanical defects are detected, whereas brief fluctuations are eliminated.

If dltErrP overshoots the defined threshold value dltErrPMax, the counter cntErrP is increased by the increment inc, as already described above. If dltErrP undershoots the threshold value dltErrPMax, the counter cntErrP is lowered by the decrement dec. The result is then stored and is compared with the threshold value cntErrPMax. Should the counter cntErrP have reached or overshoot the threshold value cntErrPMax, then a fault entry is initiated by setting stErrP:=1 and an emergency running function is activated. Furthermore, the monitoring algorithm is stopped. Only in the next ignition run is monitoring restarted again, the fault entry in the fault store being reset and the occurrence of the fault being documented by an internal fault counter.

By means of the parameterized incrementation inc or decrementation dec of the counter cntErrP, first, not only is a point pressure anomaly detected and documented, which, however, does not lead immediately to an action, but such a pressure anomaly is first checked for a longer time. A selfhealing of the fault thus becomes possible as a result of this preferably different incrementation and decrementation (that is to say, inc dec) of the counter cntErrP. If more importance is given to an as early as possible triggering of a reaction for correcting a fault, then inc>dec is selected. Otherwise, priority is given, instead, to the availability of the system.

The present invention has the advantage that pressure signal monitoring is decoupled in time from the generation of a fault signal. Pressure signal monitoring in this case does not react immediately to any deviation of the actual pressure from the desired pressure, but, instead, longterm observation or monitoring of the system is possible. Depending on the dimensioning of the incrementation or decrementation, that is to say of the values for inc and dec, a selfhealing of faults which occur is possible. By suitable adaptation or optimization of the values for inc and dec, the focus of the monitoring method may be either the triggering of an emergency running reaction or the preservation of the availability of the transmission. In any event, the protection of the transmission against further even more serious damage can be achieved by means of the monitoring method described.

Although the present invention was described above with reference to a preferred exemplary embodiment, it is not restricted to this, but can be modified in many different ways.

Thus, the invention is not restricted to the special sequence of the algorithm illustrated in the above figures. On the contrary, this very algorithm may be modified in any desired way, without departing from the basic principle of the invention. In particular, the invention is not restricted to the CVT transmissions mentioned, but can, of course, also be extended to other kinds of transmissions and transmission types, such as, for example, to automatic transmissions, manual transmissions, transmissions with continuous or staged stepup, etc., even though the invention is particularly advantageous in the CVT transmissions mentioned.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for monitoring an adhesion-actuated transmission, in particular a CVT transmission, at least one monitoring variable being detected and a fault signal being generated as a function of comparison results, wherein, in a first comparison step, at least the at least one monitoring variable is correlated with reference data and a counter value is incremented or decremented as a function of the correlation result, and wherein, in a second comparison step, the counter value is compared with a counter threshold value, and a fault signal is generated in the event of an overshooting of the counter threshold value.

2. The method as claimed in claim 1, wherein, in the first comparison step, the overshooting or undershooting of a threshold value for a function of the monitoring variable is interrogated, and wherein the counter value is incremented or decremented in the event of the overshooting or undershooting of the threshold value.

3. The method as claimed in claim 2, wherein, in the first comparison step, the at least one monitoring variable is correlated with a monitoring variable reference value in that a deviation of the at least one monitoring variable from the reference value is determined, and a function of the deviation is compared with the threshold value.

4. The method as claimed in claim 3, wherein, in a further processing step, a further-processed deviation signal is determined as a function of the determined deviation by a weighting and/or filtration and/or limitation of the determined deviation.

5. The method as claimed in claim 1, wherein the monitoring of the adhesion-actuated transmission is carried out with the aid of a data processing monitoring algorithm, a diagnostic signal being used as a first input signal for starting the monitoring algorithm, and the monitoring variable and/or the determined deviation and/or the further-processed deviation signal being used as a second input signal of the monitoring algorithm.

6. The method as claimed in claim 5, wherein the diagnostic signal is generated from diagnostic data of an electronic transmission control and from diagnostic data of further devices functionally connected to the transmission.

7. A data store with stored data or data-representing signal trains, the data constituting a monitoring algorithm for an adhesion-actuated transmission for running in an electronic transmission control, wherein the monitoring algorithm contains:
a first comparison routine, in which a monitoring variable is read in by a sensor, is correlated with reference data which are stored in a reference data store, and a counter value is incremented or decremented as a function of the correlation result, and
a second comparison routine, in which the counter value is compared with a counter threshold value stored in a counter threshold value store, and a fault signal is generated in the event of the overshooting of the counter threshold value.

8. A method for monitoring an adhesion-actuated transmission, comprising:
detecting a monitoring variable;
in a first comparison step, correlating the monitoring variable with a reference value;
incrementing or decrementing a counter value as a function of the correlation result;
in a second comparison step, comparing the counter value with a counter threshold value;
generating a fault signal in the event of an overshooting of the counter threshold value; and
generating a fault signal as a function of comparison results.

9. The method as claimed in claim 8, further comprising, in the first comparison step, interrogating the overshooting or undershooting of a threshold value for a function of the monitoring variable, and incrementing or decrementing the counter value in the event of the overshooting or undershooting of the threshold value.

10. The method as claimed in claim 9, further comprising, in the first comparison step, correlating the monitoring variable with a monitoring variable reference value in that a deviation of the monitoring variable from the reference value is determined, and comparing a function of the deviation with the threshold value.

11. The method as claimed in claim 10, further comprising, in a further processing step, determining a further-processed deviation signal as a function of the determined deviation by at least one of weighting, filtration and limitation of the determined deviation.

12. The method as claimed in claim 8, further comprising carrying out the monitoring of the adhesion-actuated transmission with the aid of a data processing monitoring algorithm, using a diagnostic signal as a first input signal for starting the monitoring algorithm, and using at least one of the monitoring variable, the determined deviation and the further-processed deviation signal as a second input signal of the monitoring algorithm.

13. The method as claimed in claim 12, further comprising generating the diagnostic signal from diagnostic data of an electronic transmission control and from diagnostic data of further devices functionally connected to the transmission.

14. A data store comprising stored data or data representing signal trains, the data including a monitoring algorithm for an adhesion-actuated transmission for running in an electronic transmission control, wherein the monitoring algorithm including:
a first comparison routine, in which a monitoring variable is read in by a sensor and is correlated with reference data which are stored in a reference data store, and a counter value is incremented or decremented as a function of the correlation result, and
a second comparison routine, in which the counter value is compared with a counter threshold value stored in a counter threshold value store, and a fault signal is generated in the event of the overshooting of the counter threshold value.
